(19) United States
(12) Patent Application Publication
(10) Pub. No.: US 2011/0056257 A1
(43) Pub. Date: Mar. 10, 2011

(54) Spring latch cam for a cam lock

(76) Inventor: Thomas J. DiVito, Southington, CT (US)

(21) Appl. No.: 12/584,499

(22) Filed: Sep. 8, 2009

(51) Int. Cl. E05B 15/00

(52) U.S. Cl. 70/266

(57) ABSTRACT

This is a cam lock that has a spring loaded latching cam. The cam has a ramp that allows it to be moved by a blocked surface without the normal radial turning of the plug. The cam retracts in a lateral motion to clear and then pass behind the blocking surface. This way a cam lock can be pushed to closed position rather than rotated.

### BACKGROUND OF INVENTION

1) Field of Invention

The present invention provides a locking method for a cam lock by its attached cam member. Typically, cam lock applications achieve the lock blocking function by the radial rotation of said cam. In particular this invention achieves the same blocking function without the rotation of the cam.

2) Description of the Prior Art

Cam locks are well known in the art. Cam locks are often employed to hold doors, drawers, and lids shut by rotating a cam behind a blocking surface. When the cam is rotated away from the blocking surface the door can be opened. Cam members which attach to the cam locks are designed with an opening in one end of the cam that exactly matches the shape of the cam lock drive stud. Typically, a key is used in the cam lock to allow rotation of the cam to achieve both the locking and unlocking function.

### SUMMARY OF THE INVENTION

The present invention overcomes the requirement to lock a cam lock using a key and radial rotation.

A cam lock in accordance with the present invention includes a conventional cam lock with locking rotatable plug and shell configuration operable by a properly bitted key. At the end oppositely opposed to the lock face, the plug shall have a fixed shape drive stud on which a cam member can be attached to provide locking. The drive stud portion of the plug will have a count bore perpendicular to the drive stud to accommodate a partial seating of the latch spring. A cam guide washer will fit over the drive stud. A cam member with elongated opening will fit over the drive stud. The elongated opening shall allow for retraction sufficient to pass by its intended blocking surface and subsequent extension to provide sufficient blocking to prevent opening without the properly bitted key. A coiled spring will have one end fit inside the pocket in the cam and the other end inside the counter bore in the stud drive. A lock washer and nut or screw will retain the cam on the cam lock

Some cam locks may require the addition of a collar to adjust the cam to the proper height against the blocked surface. The cam lock may be retained in its door by a body nut. A cam stop may be used to limit the rotation of the cam to a specific direction or amount of travel.

When a cam lock is installed in a device, the cam must be moved to an unlocked position in order for the door to be closed. The door is shut and the cam is rotated behind the blocking surface of the device to prevent the door from being opened with the appropriate key. A spring loaded cam on a locked cam lock as described herein will retract when its ramped surface comes in contact with the edge of the blocking surface of the device. The spring will push the cam to the locked position as soon as it clears the blocking surface. A key can be used to rotate the spring latch to an unlocked position to allow the door to be opened.

### BRIEF DESCRIPTION OF THE DRAWINGS

The present invention may be better understood from the detailed description given here and by reference to the accompanying drawings in which:

FIG. 1 is an exploded perspective of a cam lock with a spring latch cam in accordance with the present invention;

FIG. 2 is an assembled side view of FIG. 1 in a locked state;

FIG. 3 is a top view of an unassembled cam lock in accordance with the present invention;

FIG. 4 is a side view of FIG. 3;

FIG. 5 is a side cross sectional view of the cam in accordance with the present invention;

FIG. 6 is a top view (front view when assembled in a cam lock) of the cam in FIG. 5.

### DETAILED DESCRIPTION OF THE INVENTION

With reference to the drawings, a preferred embodiment of a spring latch cam for a cam lock in accordance with the present invention has been shown.

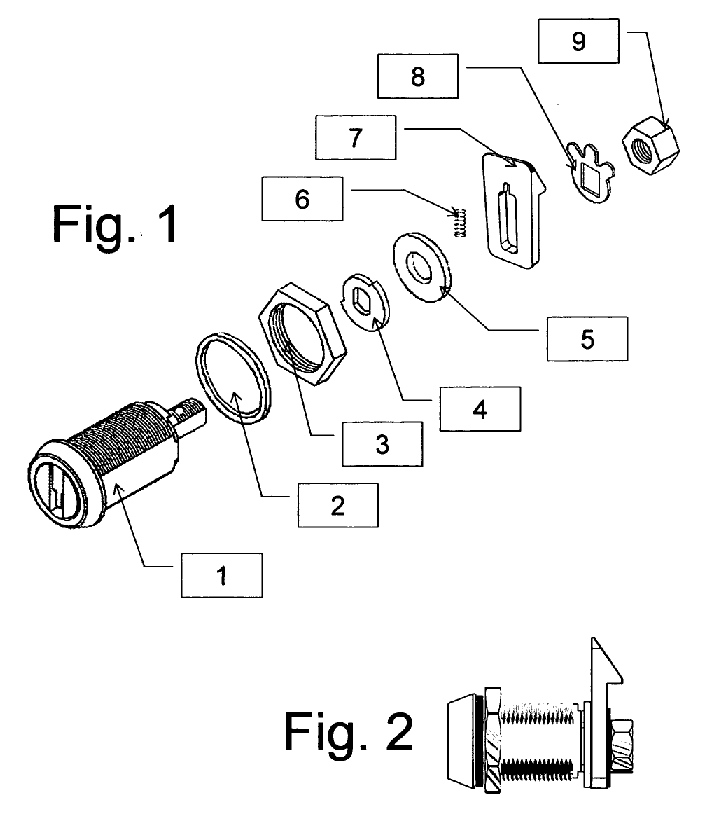

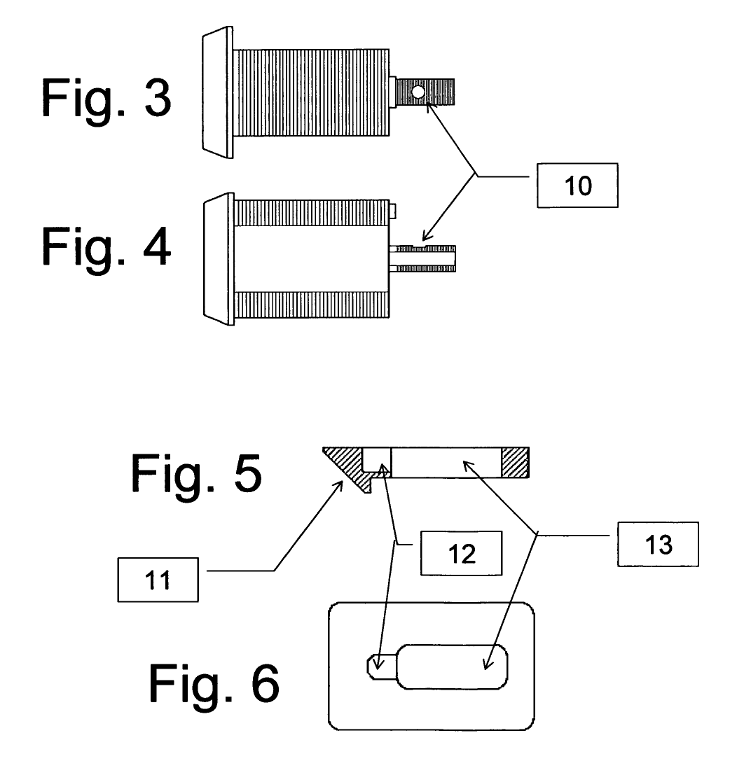

Referring to FIG. 1 a typical unassembled cam lock 1 is shown. A cam lock operates with a properly bitted key moving internal pins or discs to a common shear line so that the plug can rotate within a housing. The housing typically has threads which allow mounting in a door. The end of the plug opposite where the key is inserted will have a drive stud. A collar 2 may be used to adjust the height of a cam lock. A body nut 3 is used to retain the cam lock in an door. A cam stop washer 4 will have an exact shape to the drive stud. A cam guide washer 5 will fit over the drive stud and provide a surface for the cam to ride against. The spring latch cam 7 will fit over the drive stud. The ends of a coiled spring 6 will partially fit inside the cam and partially inside the cam stud. A three finger lock washer 8 will fit over drive stud. A cam nut 9 will retain the stop washer, cam guide, the cam, and the lock washer. The lock washer will be fastened to allow for linear movement of the cam.

A shallow counter bore 10 is the only modification required of typical cam locks to accommodate the spring latch cam invention. The counter bore 10 provides a stable base for one end of the spring 6. The counter bore 10 will be positioned on the side facing the pocket in the cam lock 12.

The cam 7 will have three unique features.
A ramped edge 11 on the locking end of the cam will allow the blocking surface to push the cam in a linear direction against the pressure of the spring and allow the door to close without cam rotation.
The opening in the cam 13 will be an elongated shape of the drive stud. The exact size and shape of the opening is to be determined by the amount of travel required to clear the blocking surface, the amount of locking engagement, and the shape of the drive studs.
The cam will have a pocket in the top surface (opposite the ramp) to accommodate one end of the spring 6.

What is claimed is:

1. A cam for a cam lock comprising:
a cam affixed to the stud of cam lock through an opening in the cam;
a ramped edge of the cam to engage a blocking surface, said shape of ramp to allow the blocking surface to displace the cam laterally away from the blocking surface;
an opening in the cam that is elongated to allow lateral movement of the cam caused by said blocking surface, said elongation to be sufficient to allow the lateral movement of the cam to both interfere and clear the blocking surface,
a cavity extending from the opening in the cam toward the ramped edge to accommodate a spring.

2. The stud of a cam lock which has a shallow counter bore to accept the end of a spring that is located inside the opening of the cam.
